(19) United States
(12) Patent Application Publication
(10) Pub. No.: US 2023/0223169 A1
(43) Pub. Date: Jul. 13, 2023

(54) CABLE WITH SEPARABLE ELECTRICAL CONDUCTORS

(71) Applicant: Corning Research & Development Corporation, Corning, NY (US)

(72) Inventor: James Arthur Register, III, Hickory, NC (US)

(21) Appl. No.: 18/122,821

(22) Filed: Mar. 17, 2023

Related U.S. Application Data
(63) Continuation of application No. PCT/US2021/050014, filed on Sep. 13, 2021.
(60) Provisional application No. 63/082,607, filed on Sep. 24, 2020.

(51) Int. Cl. H01B 7/00; H01B 13/14; H01B 1/02; H01B 9/00; G02B 6/44

(52) U.S. Cl. CPC H01B 7/009; H01B 13/141; H01B 1/02; H01B 9/005; G02B 6/4403

(57) ABSTRACT

A cable includes a first copper conductor and a second copper conductor, and an insulation layer. The insulation layer is formed from a first polymer material, and is a single layer surrounding the first copper conductor and the second copper conductor. A discontinuity formed from a second polymer material is located within the insulation layer, between the first copper conductor and the second copper conductor. The discontinuity provides a weakness within the insulation layer. A jacket surrounds the insulation layer and is made of a third polymer material. A fiber optic ribbon may be located in the cable.

### CROSS-REFERENCE TO RELATED APPLICATIONS

This application is a continuation of International Application No. PCT/US2021/050014 filed Sep. 13, 2021, which claims the benefit of priority of U.S. Provisional Application Ser. No. 63/082,607 filed on Sep. 24, 2020, the content of which is relied upon and incorporated herein by reference in its entirety.

### BACKGROUND

The present invention is related to cables and, more particularly, to a cable with separable electrical conductors. Standard conductor cables tend to have a large cross section and include multiple separate elements that are independently insulated and stranded. Such typical conductor cables allow for separate elements to be separated due to the independent insulation.

### SUMMARY

One embodiment of the disclosure relates to a cable including a first copper conductor, a second copper conductor, and an insulation layer formed from a first polymer material. The insulation layer is a single layer surrounding the first copper conductor and the second copper conductor, and is contiguous and continuous circumferentially around the first copper conductor and the second copper conductor for at least 10 cm in a longitudinal direction. A discontinuity, formed from a second polymer material, is located within the insulation layer and positioned between the first copper conductor and the second copper conductor. The discontinuity provides a weakness within the insulation layer. A jacket surrounds the insulation layer, and includes a third polymer material.

An additional embodiment of the disclosure relates to a cable including a first electrical conductor, a second electrical conductor, and an insulation layer formed from a first polymer material. The insulation layer is a single layer surrounding the first electrical conductor and the second electrical conductor, and is contiguous and continuous for at least 10 cm in a longitudinal direction. A discontinuity, formed from a second polymer material, is located within the insulation layer and positioned between the first electrical conductor and the second electrical conductor. The discontinuity provides a weakness within the insulation layer. A jacket surrounds the insulation layer, and includes a third polymer material. An optical fiber ribbon is located within the discontinuity between the first electrical conductor and the second electrical conductor in a radial direction when the cable is viewed in a cross-section taken perpendicular to a longitudinal axis of the cable. The optical fiber ribbon includes a plurality of optical fibers aligned in a plane and embedded in a polymeric ribbon matrix.

An additional embodiment of the disclosure relates to a method of forming a cable. The method includes passing a first copper conductor and a second copper conductor together through an extrusion head. A single contiguous insulation layer is extruded around both the first copper conductor and the second copper conductor. A cable jacket is extruded around the single contiguous insulation layer.

Additional features and advantages will be set forth in the detailed description that follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding and are incorporated in and constitute a part of this specification. The drawings illustrate one or more embodiment(s), and together with the description serve to explain principles and the operation of the various embodiments.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a cross-sectional view of a cable, according to an exemplary embodiment.

FIG. 2 is a cross-sectional view of a hybrid cable, according to another exemplary embodiment.

FIG. 3 is a cross-sectional view of a cable, according to another exemplary embodiment.

FIG. 4 is a cross-sectional view of a cable, according to another exemplary embodiment.

FIG. 5 is a flow chart of a method for making a cable, according to an exemplary embodiment.

FIG. 6 is a flow chart of a method for making a cable, according to another exemplary embodiment.

### DETAILED DESCRIPTION

Referring generally to the figures, embodiments of the present disclosure relate to a cable with separable electrical conductors. In particular, the designs discussed herein include multiple, separate electrical conductors located within a single, contiguous, and continuous insulation layer. In various embodiments, that single insulation layer includes a discontinuity that improves the separability of the electrical conductors from each other, while at the same time providing the processing and size benefits of a single insulation layer. In addition, in some embodiments, the cables discussed herein include a fiber optic ribbon located between the copper conductors.

In certain configurations, Applicant has found that the design discussed herein facilitates small form factor copper or copper-fiber hybrid cables. In particular, Applicant has found that pie-shaped copper conductors in a copper-fiber hybrid cable increases power density of the cable. In some designs, smaller copper conductors also allow for better bending characteristics of the cable for a given power conduction level due to the increased power density of the cable. In specific designs, inclusion of an optical fiber ribbon between pie-shaped copper conductors provides a cable design that allows for delivery of both optical communication functionality and electrical power (e.g., to power wireless networking equipment) in a compact and space-efficient form factor. Further, in specific designs, the relative positioning of optical fibers relative to the conductor elements provides mechanical protection of the optical fiber ribbon.

Furthermore, in various embodiments, Applicant has developed a method for forming such cables utilizing a process in which the common insulation layer of the electrical conductors in the cable is extruded around multiple electrical conductors at the same time and in the same extrusion step (e.g., via extrusion from a single extrusion head). Applicant has found that a method of forming such a cable allows for the electrical conductors to be processed simultaneously in a single pass and incorporate discontinuities, or fast access features, between the electrical conductors. In addition to single pass processing, copper conductor spacing is controlled, and optical fiber ribbons incorporated into the cable design. The discontinuities allow for separation of electrical conductors from each other and/or for fast access to the optical fiber ribbon.

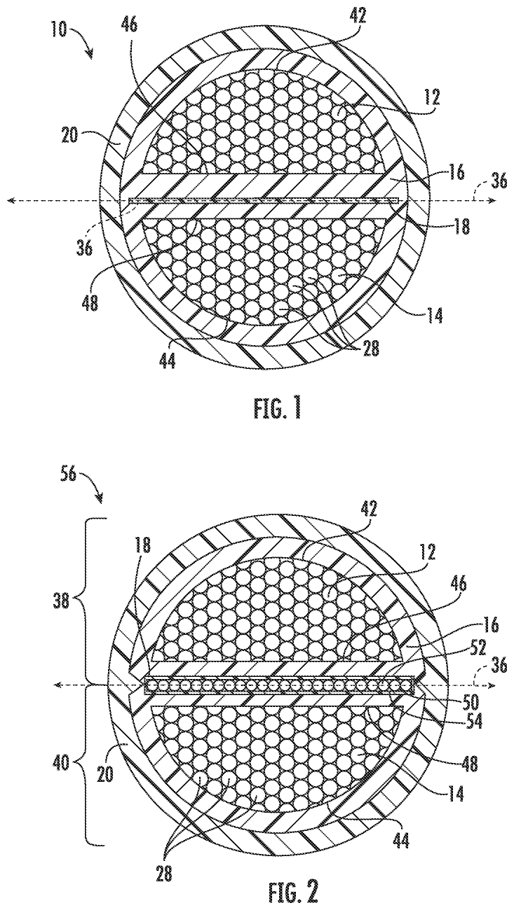

Referring to FIG. 1, a cable 10 is shown according to an exemplary embodiment. Cable 10 includes a plurality of electrical conductors, shown as first copper conductor 12 and a second copper conductor 14, and an insulation layer 16. The insulation layer 16 is formed from a first polymer material and is a single layer surrounding the first copper conductor 12 and the second copper conductor 14. The insulation layer 16 is contiguous and continuous circumferentially around the first copper conductor 12 and the second copper conductor 14 for at least 10 centimeters (cm) in a longitudinal direction. In other embodiments, the insulation layer 16 is contiguous and continuous circumferentially around the first copper conductor 12 and the second copper conductor 14 for at least 1 meter (m) or for the entire length of the cable. As will be discussed in more detail below, the insulation layer 16 is formed via a single extrusion step and provides for a small form factor, as compared to cables with individually insulated electrical conductors.

Cable 10 includes discontinuity 18 formed from a second polymer material (e.g., that is different from the first material of insulation layer 16) that is located within the insulation layer 16. In general, discontinuity 18 provides for a weakness (i.e. a separability between first copper conductor 12 and second copper conductor 14) within insulation layer 16 that allows for first copper conductor 12 and second copper conductor 14 to be easily separated from each other and routed separately. In the specific embodiment shown, discontinuity 18 is positioned between the first copper conductor 12 and the second copper conductor 14, generally located within a central plane, as shown in FIG. 1, facilitating this separation.

In various embodiments, the first material from which insulation layer 16 is formed includes a variety of thermoplastic materials, such as various polyethylene and polypropylene materials. In various embodiments, the second material of discontinuity 18 is a thermoplastic material different from the material of insulation layer 16, and may include a variety of different thermoplastic materials, such as various polyethylene and polypropylene materials. In various embodiments, insulation layer 16 and/or discontinuity 18 may be formed from polypropylene, polyethylene, blends of polyethylene and ethylene vinyl acetate, engineered polyolefin blends (one example being Apolhya®, a polyamide-grafted polyolefin, polyamid and polyamid blends), flame retardant materials (e.g., flame retardant polyethylene, polyvinylchloride, and polyvinylidene difluoride-filled materials such as polybutylene terephthalate, polycarbonate and/or polyethylene and/or ethylene vinyl acrylate), or other blends having fillers such as a chalk or talc.

Cable 10 includes jacket 20 which surrounds the insulation layer 16. In specific embodiments, jacket 20 is made of a third polymer material, which may be different from at least one of the polymer material of the insulation layer 16 and the polymer material of discontinuity 18. In various embodiments, cable jacket 20 may be made of a variety of materials used in cable manufacturing, such as polyethylene, polyvinyl chloride (PVC), polyvinylidene difluoride (PVDF), nylon, polypropylene, polyester or polycarbonate and their copolymers. In addition, the material of cable jacket 20 may include small quantities of other materials or fillers that provide different properties to cable jacket 20. For example, the material of cable jacket 20 may include materials that provide for coloring, UV/light blocking (e.g., carbon black), fire resistance as discussed above, etc.

In specific embodiments, the polymer material of discontinuity 18 is co-extrudable with the polymer material of insulation layer 16. In various embodiments, a bond strength between the polymer material of discontinuity 18 and the first material of insulation layer 16 is less than an internal bond strength within insulation layer 16 which provides for the weakness/separability as noted above. The discontinuity 18 allows the insulation layer 16 to tear along the discontinuity, which in turn allows the first copper conductor 12 to be separated from the second copper conductor 14.

As shown in FIG. 1, the cable 10 includes a central plane 36 dividing the cable 10 into a first half 38 and a second half 40. In the arrangement shown in FIG. 2, the central plane 36 resides within the discontinuity 18. In this arrangement, first copper conductor 12 is located on one side of central plane 36 and second copper conductor 14 is located on the other side of central plane 36. In one embodiment, first copper conductor 12 and second copper conductor 14 have cross-sectional areas that are substantially the same as each other (e.g., within 10% of each other). In a specific embodiment, first copper conductor 12 and second copper conductor 14 have the same cross-sectional area.

As shown in FIG. 1, when viewed in axial cross-section, the first copper conductor 12 and the second copper conductor 14 each has a curved outer surface section 42, 44 and a planar outer surface section 46, 48. The discontinuity 18 is located between the planar outer surface section 46 of the first copper conductor 12 and the planar outer surface section 48 of the second copper conductor 14.

In general, the designs of the cables discussed herein utilizing the common insulation layer are believed to allow for higher levels of conductor density and consequently power density than is typically believed to be provided in conductor cables. In specific embodiments, first copper conductor 12 and second copper conductor 14 each includes a plurality of smaller copper conductors 28. In various embodiments, the smaller copper conductors 28 are packed within the insulation layer at a density greater than 80%, for example from 80% to 100% and more specifically between 80% to 90%.

Referring to FIG. 2, a cable, shown as hybrid cable 56, is shown according to an exemplary embodiment. Cable 56 is substantially the same as cable 10 (FIG. 1) except for the differences discussed herein. Cable 56 includes an optical fiber ribbon 50 located within the discontinuity 18 between the first copper conductor 12 and the second copper conductor 14 in a radial direction when the cable 10 is viewed in a cross-section taken perpendicular to a longitudinal axis of the cable 10. The optical fiber ribbon 50 includes a plurality of optical fibers 52 aligned in a plane and embedded in a polymeric ribbon matrix.

Similar to the arrangement in cable 10, in cable 56, discontinuity 18 allows the insulation layer 16 to tear along the discontinuity, which in turn allows the first copper conductor 12 to be separated from the second copper conductor 14. In cable 56, the separation of the first copper conductor 12 from the second copper conductor 14 provides access to the optical fiber ribbon 50. Optical fiber ribbon 50 (or one or more optical fibers of optical fiber ribbon 50) can then be routed as desired to provide optical network communication to one or more devices or users.

Similar to cable 10, cable 56 includes central plane 36 that resides within the discontinuity 18. However, in cable 56, the optical fiber ribbon 50 is supported within cable 56 such that central plane 36 generally aligns with the central ribbon plane. In this arrangement, the polymer material of the insulation layer 16 and/or the polymer material of discontinuity 18 contacts an outermost surface 54 of the optical fiber ribbon 50.

In specific embodiments of both cable 10 (FIG. 1) and cable 56 (FIG. 2), first copper conductor 12 and second copper conductor 14 have an American Wire Gauge (AWG) equivalent of between 10 and 30 and specifically of between 12 and 24. In such embodiments, the conductor packing density within each insulation layer for each conductor is greater than 80% and specifically is 80% to 90%. In specific embodiments, cable 10 and/or cable 56 includes an outer diameter of 3 mm to 6 mm, specifically of 3.5 mm to 5 mm. In a specific embodiment, cable 10 and/or cable 56 includes an outer diameter of 4.0 mm, and in another specific embodiment, cable 10 and/or cable 56 includes an outer diameter of 4.8 mm.

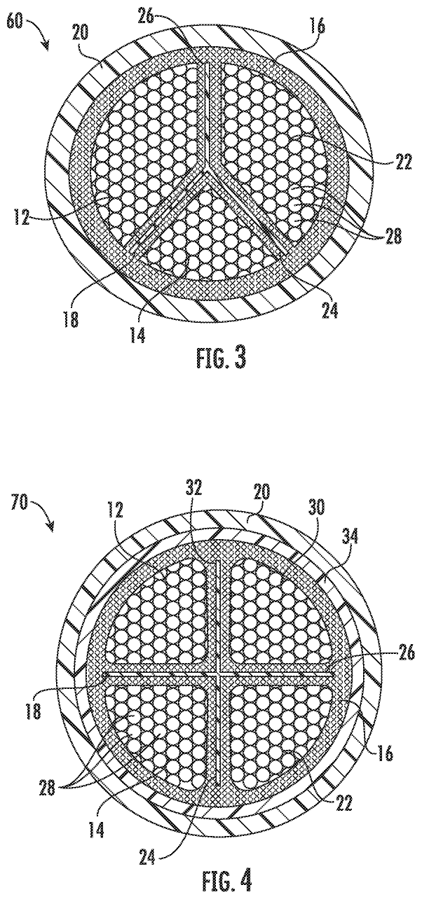

Referring to FIG. 3, a cable 60 is shown according to another embodiment. Cable 60 is substantially the same as cable 10 discussed above, except for the differences discussed herein. Cable 60 includes a third copper conductor 22 surrounded by the insulation layer 16. To provide for separation of each of the conductors from each other, cable 60 includes a second discontinuity 24 and a third discontinuity 26. Second discontinuity 24 is formed from the second polymer material (i.e. a material that is different from the first polymer material of insulation layer 16 as discussed herein) that is located within the insulation layer 16 between the second copper conductor 14 and the third copper conductor 22. Similar to discontinuity 18, the second discontinuity 24 provides a second weakness (i.e., a separability between second copper conductor 14 and third copper conductor 22) within the insulation layer 16. Third discontinuity 26 formed from the second polymer material is located within the insulation layer 16 between the first copper conductor 12 and the third copper conductor 22. The third discontinuity 26 provides a third weakness (i.e., a separability between first copper conductor 12 and third copper conductor 22) within the insulation layer 16. In an embodiment, first copper conductor 12, second copper conductor 14, and third copper conductor 22 have substantially the same cross-sectional areas (e.g., within 10% of each other). In a specific embodiment, first copper conductor 12, second copper conductor 14, and third copper conductor 22 each have the same cross-sectional area as each other. In another embodiment, one or more of copper conductors 12, 14, and 22 have a cross-sectional area that is different from each other.

In general, discontinuities 24 and 26 are formed and function the same as discontinuity 18 discussed above. Thus in such embodiments, the second discontinuity 24 allows the insulation layer 16 to tear along the discontinuity 18, which in turn allows the second copper conductor 14 to be separated from the third copper conductor 22. The third discontinuity 26 allows the insulation layer 16 to tear along the discontinuity 18, which in turn allows the first copper conductor 12 to be separated from the third copper conductor 22.

Referring to FIG. 4, a cable 70 is shown according to an exemplary embodiment. Cable 70 is substantially the same as cable 10 discussed above, except for the differences discussed herein. Cable 70 includes a third copper conductor 22 surrounded by the insulation layer 16 and a fourth copper conductor 30 surrounded by the insulation layer 16. A second discontinuity 24 formed from the second polymer material (i.e. a material that is different from the first polymer material of insulation layer 16 as discussed herein) is located within the insulation layer 16, and positioned between the second copper conductor 14 and the third copper conductor 22. The second discontinuity 24 provides a second weakness (i.e. a separability between second copper conductor 14 and third copper conductor 22) within the insulation layer 16. A third discontinuity 26 formed from the second polymer material is located within the insulation layer 16, and positioned between the third copper conductor 22 and the fourth copper conductor 30. The third discontinuity 26 provides a third weakness (i.e. a separability between third copper conductor 22 and fourth copper conductor 30) within the insulation layer 16. A fourth discontinuity 32 formed from the second polymer material is located within the insulation layer 16, and positioned between the fourth copper conductor 30 and the first copper conductor 12. The fourth discontinuity 32 provides a fourth weakness (i.e. a separability between fourth copper conductor 30 and first copper conductor 12) within the insulation layer 16. In an embodiment, first copper conductor 12, second copper conductor 14, third copper conductor 22, and fourth copper conductor 30 have substantially the same cross-sectional areas (e.g., within 10% of each other). In a specific embodiment, first copper conductor 12, second copper conductor 14, third copper conductor 22, and fourth copper conductor 30 each have the same cross-sectional area as each other.

In a specific embodiment, cable 70 includes at least one additional layer 34 located between the insulation layer 16 and the jacket 20. In various embodiments, additional layer 34 may be an armor layer, a tensile strength layer (e.g. aramid yarn), and/or a water-blocking layer containing a super-absorbent polymer or water-blocking yarn/tape. However, it is contemplated that other suitable layers and corresponding materials may be used.

In general, discontinuities 24, 26, and 32 are formed and function the same as discontinuity 18 discussed above. Thus in such embodiments, second discontinuity 24 allows the insulation layer 16 to tear along discontinuity 24, which in turn allows the second copper conductor 14 to be separated from the third copper conductor 22. The third discontinuity 26 allows the insulation layer 16 to tear along discontinuity 26, which in turn allows the third copper conductor 22 to be separated from the fourth copper conductor 30. The fourth discontinuity 32 allows the insulation layer 16 to tear along discontinuity 32, which in turn allows the first copper conductor 12 to be separated from the fourth copper conductor 30.

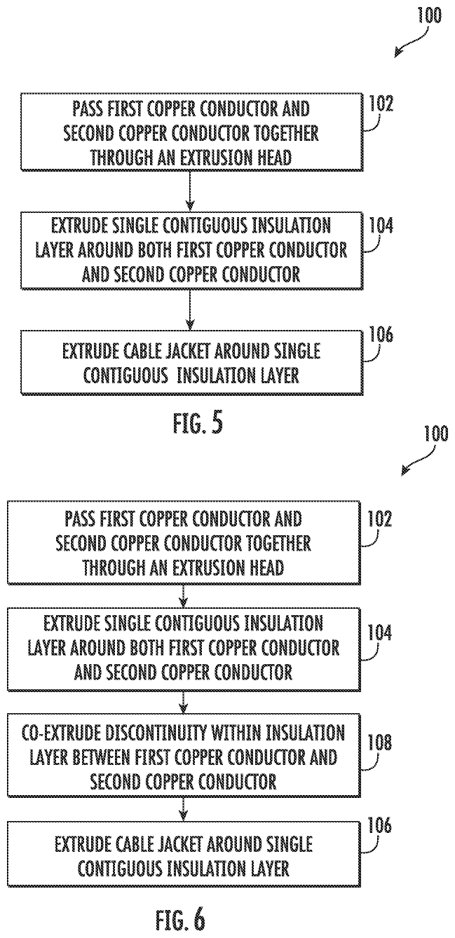

Further, referring to FIG. 5 and FIG. 6, the present disclosure relates to a method 100 of forming a cable, such as cable 10. In the method, at step 102, a first copper conductor, such as copper conductor 12, and a second copper conductor, such as copper conductor 14, are passed together through an extrusion head. At step 104, a single contiguous insulation layer, such as insulation layer 16, is extruded around both the first copper conductor and the second copper conductor. At step 106, a cable jacket, such as cable jacket 20, is extruded around the single contiguous insulation layer. The single-pass process allows for more efficient production, and thus lower cost, of the cable design.

In specific embodiments, shown in FIG. 6, at step 108, a discontinuity, such as discontinuity 18, is co-extruded within the insulation layer 16 located between the first copper conductor 12 and the second copper conductor 14. In such embodiments, as discussed above in relation to FIG. 1, the insulation layer 16 is formed from a first polymer material, and the discontinuity 18 is formed from a second polymer material that is different from the first polymer material. In various embodiments, additional cable components, such as optical fiber ribbon 50, may be passed through the extrusion head to form a hybrid cable, such as cable 56 discussed above.

The optical fibers discussed herein may be flexible, transparent optical fibers made of glass or plastic. The fibers may function as a waveguide to transmit light between the two ends of the optical fiber. Optical fibers may include a transparent core surrounded by a transparent cladding material with a lower index of refraction. Light may be kept in the core by total internal reflection. Glass optical fibers may comprise silica, but some other materials such as fluorozirconate, fluoroaluminate and chalcogenide glasses, as well as crystalline materials such as sapphire, may be used. The light may be guided down the core of the optical fibers by an optical cladding with a lower refractive index that traps light in the core through total internal reflection. The cladding may be coated by a buffer and/or another coating(s) that protects it from moisture and/or physical damage. These coatings may be UV-cured urethane acrylate composite materials applied to the outside of the optical fiber during the drawing process. The coatings may protect the strands of glass fiber.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is in no way intended that any particular order be inferred. In addition, as used herein, the article “a” is intended to include one or more than one component or element, and is not intended to be construed as meaning only one.

It will be apparent to those skilled in the art that various modifications and variations can be made without departing from the spirit or scope of the disclosed embodiments. Since modifications, combinations, sub-combinations and variations of the disclosed embodiments incorporating the spirit and substance of the embodiments may occur to persons skilled in the art, the disclosed embodiments should be construed to include everything within the scope of the appended claims and their equivalents.

What is claimed is:

1. A cable comprising:
a first copper conductor;
a second copper conductor;
an insulation layer formed from a first polymer material, wherein the insulation layer is a single layer surrounding the first copper conductor and the second copper conductor and is contiguous and continuous circumferentially around the first copper conductor and the second copper conductor for at least 10 cm in a longitudinal direction;
a discontinuity formed from a second polymer material located within the insulation layer and positioned between the first copper conductor and the second copper conductor, wherein the discontinuity provides a weakness within the insulation layer; and
a jacket surrounding the insulation layer, the jacket comprising a third polymer material.

2. The cable of claim 1, wherein the second polymer material is co-extrudable with the first polymer material, wherein a bond strength between the second polymer material and the first polymer material is less than an internal bond strength of the first polymer material such that the discontinuity allows the insulation layer to tear along the discontinuity thereby allowing the first copper conductor to be separated from the second copper conductor.

3. The cable of claim 1, further comprising:
a third copper conductor surrounded by the insulation layer;
a second discontinuity formed from the second polymer material located within the insulation layer and positioned between the second copper conductor and the third copper conductor, wherein the second discontinuity provides a second weakness within the insulation layer; and
a third discontinuity formed from the second polymer material located within the insulation layer and positioned between the first copper conductor and the third copper conductor, wherein the third discontinuity provides a third weakness within the insulation layer.

4. The cable of claim 3, wherein the second polymer material is co-extrudable with the first polymer material, wherein a bond strength between the second polymer material and the first polymer material is less than an internal bond strength of the first polymer material such that the discontinuity allows the insulation layer to tear along the discontinuity thereby allowing the first copper conductor to be separated from the second copper conductor, the second discontinuity allows the insulation layer to tear along the second discontinuity thereby allowing the second copper conductor to be separated from the third copper conductor, and the third discontinuity allows the insulation layer to tear along the third discontinuity thereby allowing the first copper conductor to be separated from the third copper conductor.

5. The cable of claim 3, wherein the first copper conductor, the second copper conductor, and the third copper conductor each comprises a plurality of smaller copper conductors, the plurality of smaller copper conductors packed within the insulation layer at a density from 80% to 100%.

6. The cable of claim 1, further comprising:
a third copper conductor surrounded by the insulation layer;
a fourth copper conductor surrounded by the insulation layer; and
a second discontinuity formed from the second polymer material located within the insulation layer and positioned between the second copper conductor and the third copper conductor, wherein the second discontinuity provides a second weakness within the insulation layer;
a third discontinuity formed from the second polymer material located within the insulation layer and positioned between the third copper conductor and the fourth copper conductor, wherein the third discontinuity provides a third weakness within the insulation layer;
a fourth discontinuity formed from the second polymer material located within the insulation layer and positioned between the fourth copper conductor and the first copper conductor, wherein the fourth discontinuity provides a fourth weakness within the insulation layer.

7. The cable of claim 6, wherein the second polymer material is co-extrudable with the first polymer material, wherein a bond strength between the second polymer material and the first polymer material is less than an internal bond strength of the first polymer material such that the discontinuity allows the insulation layer to tear along the discontinuity thereby allowing the first copper conductor to be separated from the second copper conductor, the second discontinuity allows the insulation layer to tear along the second discontinuity thereby allowing the second copper conductor to be separated from the third copper conductor, the third discontinuity allows the insulation layer to tear along the third discontinuity thereby allowing the third copper conductor to be separated from the fourth copper conductor, and the fourth discontinuity allows the insulation layer to tear along the fourth discontinuity thereby allowing the first copper conductor to be separated from the fourth copper conductor.

8. The cable of claim 6, wherein the first copper conductor, the second copper conductor, the third copper conductor, and the fourth copper conductor each comprises a plurality of smaller copper conductors, the plurality of smaller copper conductors packed within the insulation layer at a density from 80% to 100%.

9. The cable of claim 1, further comprising a central plane dividing the cable into a first half and a second half, wherein the central plane resides within the discontinuity.

10. The cable of claim 9, wherein, when viewed in axial cross-section, the first copper conductor and the second copper conductor each has a curved outer surface section and a planar outer surface section, wherein the discontinuity is located between the planar outer surface sections of the first copper conductor and the second copper conductor.

11. The cable of claim 1, wherein the first copper conductor and the second copper conductor each comprises a plurality of smaller copper conductors, the plurality of smaller copper conductors packed within the insulation layer at a density from 80% to 100%.

12. A cable comprising:
a first electrical conductor;
a second electrical conductor;
an insulation layer formed from a first polymer material, wherein the insulation layer is a single layer surrounding the first electrical conductor and the second electrical conductor and is contiguous and continuous for at least 10 cm in a longitudinal direction;
a discontinuity formed from a second polymer material located within the insulation layer and positioned between the first electrical conductor and the second electrical conductor, wherein the discontinuity provides a weakness within the insulation layer; and
a jacket surrounding the insulation layer, the jacket comprising a third polymer material; and
an optical fiber ribbon located within the discontinuity between the first electrical conductor and the second electrical conductor in a radial direction when the cable is viewed in a cross-section taken perpendicular to a longitudinal axis of the cable, wherein the optical fiber ribbon comprises a plurality of optical fibers aligned in a plane and embedded in a polymeric ribbon matrix.

13. The cable of claim 12, wherein the second polymer material is co-extrudable with the first polymer material, wherein a bond strength between the second polymer material and the first polymer material is less than an internal bond strength of the first polymer material such that the discontinuity allows the insulation layer to tear along the discontinuity thereby allowing the first electrical conductor to be separated from the second electrical conductor.

14. The cable of claim 12, further comprising a central plane dividing the cable into a first half and a second half, wherein the central plane resides within the discontinuity.

15. The cable of claim 14, wherein, when viewed in axial cross-section, the first electrical conductor and the second electrical conductor each has a curved outer surface section and a planar outer surface section, wherein the discontinuity is located between the planar outer surface sections of the first electrical conductor and the second electrical conductor.

16. The cable of claim 14, wherein the optical fiber ribbon is embedded within the central plane such that the first polymer material of the insulation layer contacts an outermost surface of the optical fiber ribbon.

17. The cable of claim 12, wherein the first electrical conductor and the second electrical conductor each comprises a plurality of stranded copper conductors.

18. The cable of claim 17, wherein the plurality of stranded copper conductors are packed within the insulation layer at a density greater than 80%.

19. A method of forming a cable comprising:
passing a first copper conductor and a second copper conductor together through an extrusion head;
extruding a single contiguous insulation layer around both the first copper conductor and the second copper conductor; and
extruding a cable jacket around the single contiguous insulation layer.

20. The method of claim 19, co-extruding a discontinuity within the insulation layer located between the first copper conductor and the second copper conductor, wherein the insulation layer is formed from a first polymer material and the discontinuity is formed from a second polymer material different from the first polymer material.
